(19) United States
(12) Patent Application Publication
(10) Pub. No.: US 2008/0297721 A1
(43) Pub. Date: Dec. 4, 2008

(54) LENS DESIGNS FOR TREATING ASTHENOPIA CAUSED BY VISUAL DEFECTS

(76) Inventors: Amitava Gupta, Jacksonville, FL (US); Susan W. Neadle, Jacksonville, FL (US); G. Benjmain Wooley, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/754,386

(22) Filed: May 29, 2007

(51) Int. Cl. G02C 7/04; G02C 7/02

(52) U.S. Cl. 351/161; 351/175

(57) ABSTRACT

The invention provides ophthalmic lenses that provide correction for each of refractive asthenopia, muscular asthenopia and foveal suppression.

### FIELD OF THE INVENTION

The invention relates to ophthalmic lenses. In particular, the invention provides ophthalmic lenses that provide visual acuity correction and substantially eliminate asthenopia.

### BACKGROUND OF THE INVENTION

Asthenopia, or eye fatigue, can be caused by a number of visual defects. In refractive asthenopia, refraction defects, chiefly deficits in the eye's ability to accommodate, result in eye-strain. Additionally, muscular asthenopia or deficiencies in eye movement and alignment can cause eye fatigue. Finally, foveal suppression that disrupts saccadic and pursuit eye movements and delays fixation contributes to asthenopia. The conventional lens designs do not incorporate corrective features to address each of these causes of asthenopia.

### BRIEF DESCRIPTION OF THE FIGURE

FIG. 1 depicts is a plan view of a surface of a lens of the invention.

### DETAILED DESCRIPTION OF THE INVENTION AND PREFERRED EMBODIMENTS

The invention provides methods for designing an ophthalmic lens, lenses according to the design method, and methods for producing the lenses, which lenses provide correction for each of refractive asthenopia, muscular asthenopia and foveal suppression. The invention may be used to provide any ophthalmic lens, meaning contact lenses, intraocular lenses, corneal onlay lenses and the like, but may find its greatest utility in the design and manufacture of contact lenses.

In one embodiment, the invention provides an ophthalmic lens comprising, consisting essentially of, and consisting of an optic zone comprising at its center a first region of add power and an asthenopia-correcting effective amount of prism. In another embodiment, the invention provides an ophthalmic lens comprising, consisting essentially of, and consisting of an optic zone comprising at a center of the optic zone a first region of overcorrected near vision correction and an asthenopia-correcting effective amount of prism. In still another embodiment, the invention provides a method for correcting asthenopia comprising, consisting essentially of, and consisting of providing an ophthalmic lens comprising at its center a first region of add power and an asthenopia-correcting effective amount of prism.

For purposes of the invention, by “add power” is meant dioptric power added to that needed to correct for the lens wearer's distance vision acuity. By “distance vision correction” is meant the amount of refractive power required to correct the wearer's distance vision acuity to the desired degree. By “near vision correction” is meant the amount of refractive power required to correct the wearer's near vision acuity to the desired degree. By “overcorrected near vision correction’ is meant that the near vision correction is greater than that which is required to correct for the lens wearer's near vision acuity.

In the lenses of the invention, accommodative asthenopia is addressed by placing a region of add power, in the case of a non-presbyopic lens wearer, or overcorrected near vision correction, in the case of the presbyopic lens wearer, at the center of the optic zone to increase the lens wearer's depth of focus. The region of add power or near vision correction is preferably an annular region centered about the center of the optic zone and having a diameter of about 1.5 to 3.5 mm and more preferably about 1.9 to 2.5 mm.

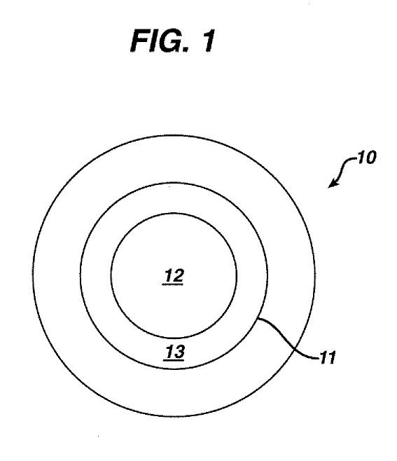

The power may be constant within the region or it may have a peak power at the center of the region with the power decreasing as one moves to the periphery of the region, meaning as one moves away from the center of the optic zone. Preferably, a region for distance vision correction surrounds the central add or near vision correction region and more preferably, the distance vision region is an annular ring. FIG. 1 depicts lens 10 of the invention with an optic zone 11 in which add power region 12 is surrounded by annular, distance vision correction region 13. An additional region of add power or overcorrected near vision correction may surround the distance vision correction region, preferably an annular ring that surrounds the distance vision correction region. If such a second region is used, the region preferably begins at a diameter of about 4 mm from the optical center of the lens and end at about 6 mm therefrom and more preferably is located at a diameter of between 4.5 and 6.5 mm from the optical center.

The amount of add power or overcorrected near vision correction used will be an amount effective to achieve the desired increase in depth of focus. Typically, the amount of power is provided in increments of 0.12 diopters and the total power preferably will be about 0.12 to 1.0 diopters. The precise amount to be used may be calculated by any of a number of know methods. For example, the lens wearer's through-focus visual acuity may be measured using a target at a fixed distance while having the lens wearer try various trial lenses. Alternatively, and preferably, a mathematical eye model may be used to test the visual acuity provided by a candidate lens design. Any number of eye models are known including, without limitation, the Gulolstrand-LeGrand and Liou-Brennen eye models. Methods of calculating visual quality are also well-known and include, without limitation, modulation transfer function, root mean square spot size, Visual Strehl and the like.

In addition to correcting for accommodative asthenopia, the lenses of the invention provide correction for muscular asthenopia by having prism incorporated into the lens design. Prism may be provided by, for example, adding a base up or base down prism into the lens, decentering the optic zone or a combination thereof. The amount of prism, in terms of magnitude and direction for the base up or base down prism or decentration, is an asthenopia-correcting effective amount meaning an amount effective to either totally or partially correct the lens wearer's muscular asthenopia. The precise amount will vary from person to person and can be determine by observation, examination and patch testing to characterize the deficit as either a phoria, such as exophoria, esophoria, hyperphoria and the like, or a tropia, such as heterotropia or the like. Once characterized, the extent of the defect may be measured by any conventional method including, without limitation, the use of the color fusion method.

If a base up or base down prism is used, the prism incorporated into the lens will have a magnitude in prism diopters or minutes of arc as well as a direction, meaning base in or out and base up or down. The prism may be incorporated into either or both the near and distance vision regions of the lens. Additionally, it may be desirable to aspherize the prismatic surface in order to reduce or substantially eliminate any image distortions induced by the added prism. The prism may be provided in increments of 0.25 diopters of base down or base in prism with the total amount of prism preferably being about 0.25 to about 2.0 diopters.

Alternatively, prism may be provided by decentration of the optic zone, which decentration will treat foveal suppression. Foveal suppression, which may occur due to the presence of microscotomas, may disrupt saccadic and pursuit eye movements, acts to delay fixation, and may inhibit binocular fusion. The amount of decentration will depend upon the extent of non-function of the lens wearer's fovea. Conveniently, the optic may be decentered from the optic center of the lens in 0.1 mm increments and preferably for a total decentration of about 0.1 to about 0.5 mm.

In the lenses of the invention, the add power or near vision and far vision zones may be on the front surface, or object side surface, the back surface, or eye side surface of the lens, or split between the front and back surfaces. Cylinder power may be provided on the back, or concave surface of the lens in order to correct the wearer's astigmatism. Alternatively, the cylinder power may be combined with either or both of the distance and add or near vision powers on the front surface or back surface.

Contact lenses useful in the invention preferably are soft contact lenses. Soft contact lenses, made of any material suitable for producing such lenses, preferably are used. Illustrative materials for formation of soft contact lenses include, without limitation silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof. More preferably, the surface is a siloxane, or contains a siloxane functionality, including, without limitation, polydimethyl siloxane macromers, methacryloxypropyl polyalkyl siloxanes, and mixtures thereof, silicone hydrogel or a hydrogel, such as etafilcon A.

A preferred lens-forming material is a poly 2-hydroxyethyl methacrylate polymers, meaning, having a peak molecular weight between about 25,000 and about 80,000 and a polydispersity of less than about 1.5 to less than about 3.5 respectively and covalently bonded thereon, at least one cross-linkable functional group. This material is described in U.S. Pat. No. 6,846,892 incorporated herein in its entirety by reference. Suitable materials for forming intraocular lenses include, without limitation, polymethyl methacrylate, hydroxyethyl methacrylate, inert clear plastics, silicone-based polymers, and the like and combinations thereof.

Curing of the lens forming material may be carried out by any means known including, without limitation, thermal, irradiation, chemical, electromagnetic radiation curing and the like and combinations thereof. Preferably, the lens is molded which is carried out using ultraviolet light or using the full spectrum of visible light. More specifically, the precise conditions suitable for curing the lens material will depend on the material selected and the lens to be formed. Polymerization processes for ophthalmic lenses including, without limitation, contact lenses are well known. Suitable processes are disclosed in U.S. Pat. No. 5,540,410 incorporated herein in its entirety by reference.

The contact lenses of the invention may be formed by any conventional method. For example, the optic zone may be produced by diamond-turning or diamond-turned into the molds that are used to form the lens of the invention. Subsequently, a suitable liquid resin is placed between the molds followed by compression and curing of the resin to form the lenses of the invention. Alternatively, the zone may be diamond-turned into lens buttons.

What is claimed is:

1. An ophthalmic lens, comprising an optic zone comprising a first region of add power at a center of the optic zone and an asthenopia-correcting effective amount of prism.

2. An ophthalmic lens, comprising an optic zone comprising a first region of overcorrected near vision correction at a center of the optic zone and an asthenopia-correcting effective amount of prism.

3. The lens of claim 1, wherein the ophthalmic lens is a contact lens.

4. The lens of claim 2, wherein the ophthalmic lens is a contact lens.

5. The lens of claim 3, further comprising a distance vision correction region.

6. The lens of claim 5, wherein the distance vision correction region is an annular region surrounding the first add power region.

7. The lens of claim 3, further comprising a second region of add power.

8. The lens of claim 7, wherein the second region of add power is an annular region surrounding the distance vision correction region.

9. The lens of claim 4, further comprising a distance vision correction region.

10. The lens of claim 9, wherein the distance vision correction region is an annular region surrounding the first near vision region.

11. The lens of claim 4, further comprising a second region of overcorrected near vision correction.

12. The lens of claim 11, wherein the second region of overcorrected near vision region is an annular region surrounding the distance vision correction region.

13. The lens of claim 3, wherein the prism is incorporated into the first add power region.

14. The lens of claim 5, wherein the prism is incorporated into the distance vision correction region.

15. The lens of claim 5, wherein the prism is incorporated into the first add power region and the distance vision correction region.

16. The lens of claim 3, wherein the optic zone is decentered.

17. The lens of claim 4 wherein the prism is incorporated into the first overcorrected near vision region.

18. The lens of claim 9, wherein the prism is incorporated into the distance vision correction region.

19. The lens of claim 9, wherein the prism is incorporated into the first overcorrected near vision correction region and the distance vision correction region.

20. The lens of claim 4, wherein the optic zone is decentered.

21. The lens of claim 3, wherein the power of the first add power correction region is substantially constant within the region.

22. The lens of claim 3, wherein the power of the first add power region has a peak at the center of the region and the power decreases from the peak to a periphery of the zone.

23. The lens of claim 4, wherein the power of the first overcorrected near vision region is substantially constant within the region.

24. The lens of claim 4, wherein the power of the first overcorrected near vision region has a peak at the center of the region and the power decreases from the peak to a periphery of the zone.

25. A method for correcting asthenopia, comprising the step of providing an ophthalmic lens comprising a first region of add power at a center of the optic zone and an asthenopia-correcting effective amount of prism.

26. A method for correcting asthenopia, comprising the step of providing an ophthalmic lens comprising a first region of overcorrected near vision correction at a center of the optic zone and an asthenopia-correcting effective amount of prism.
